(19) United States
(12) Patent Application Publication
(10) Pub. No.: US 2019/0077317 A1
(43) Pub. Date: Mar. 14, 2019

(54) VEHICLE VISUAL RECOGNITION DEVICE

(71) Applicant: KABUSHIKI KAISHA TOKAI-RIKA-DENKI-SEISAKUSHO, Aichi (JP)

(72) Inventor: Hiroyuki MUTO, Aichi (JP)

(21) Appl. No.: 16/084,372

(22) PCT Filed: Feb. 24, 2017
(86) PCT No.: PCT/JP2017/007250

§ 371 Date: Sep. 12, 2018

(30) Foreign Application Priority Data
Mar. 15, 2016 (JP) 2016-051486

(51) Int. Cl. B60R 1/072; G06K 9/00

(52) U.S. Cl. CPC B60R 1/072; G06K 9/00791

(57) ABSTRACT

In a vehicle door mirror device, an attachment wall of a mirror body is supported by a retention tube of a visor body, and a sliding wall of the mirror body is supported by a support wall of the visor body. Note that the mirror body is exposed through an opening in the visor body, and that the retention tube and the support wall are integrally provided to the visor body. This enables relative placement accuracy of a peripheral face at the opening, the retention tube, and the support wall to be improved, and enables placement accuracy of the mirror body with respect to the peripheral face at the opening to be improved.

### TECHNICAL FIELD

The present invention relates to a vehicle visual recognition device in which a visual recognition means assists visual recognition by an occupant of a vehicle.

### BACKGROUND ART

In a door mirror device described in Japanese Utility Model Application Laid-Open (JP-U) No. S63-35639, a mirror and a mirror substrate are housed in a front side case, and the mirror is exposed through an opening of the front side case. A stationary pivot is installed in the front side case. The stationary pivot supports a center side (a spacer) of the mirror substrate so as to be capable of tilting, and the front side case supports an outer peripheral side (a spherically-faced bearing portion) of the mirror substrate so as to be capable of sliding. The front side case covers a tilting mechanism and a drive mechanism, and a movable pivot of the tilting mechanism supports a spherical face shaped cavity in the mirror substrate.

Note that it is preferable to improve the placement accuracy of the mirror and the mirror substrate with respect to the peripheral face at the opening in the front side case in door mirror devices such as this.

### SUMMARY OF INVENTION

### Technical Problem

In consideration of the above circumstances, an object of the present invention is to obtain a vehicle visual recognition device capable of improving placement accuracy of a visual recognition means with respect to a peripheral face at an opening in a housing body.

### Solution to Problem

A vehicle visual recognition device of a first aspect of the present invention includes a visual recognition means and a housing body. The visual recognition means assists visual recognition by an occupant of a vehicle. The housing body houses the visual recognition means, is provided with an opening exposing the visual recognition means, and is provided with a central support portion supporting a center side of the visual recognition means so as to be capable of tilting and with an outer peripheral support portion supporting an outer peripheral side of the visual recognition means so as to be capable of sliding.

A vehicle visual recognition device of a second aspect of the present invention includes a visual recognition means, a housing body, and an operating mechanism. The visual recognition means assists visual recognition by an occupant of a vehicle. The housing body houses the visual recognition means, is provided with an opening exposing the visual recognition means, and is provided with a covering portion and with a central support portion supporting a center side of the visual recognition means so as to be capable of tilting. The operating mechanism is covered by the covering portion, supports the visual recognition means, and is operated to tilt the visual recognition means.

A vehicle visual recognition device of a fourth aspect of the present invention is the vehicle visual recognition device of any one of the first aspect to the third aspect of the present invention, further including a retention portion that is provided at one of the visual recognition means or the housing body, a biasing means that is retained by the retention portion, and an abutting portion that is provided at the other of the visual recognition means or the housing body and that is abutted by the biasing means so as to bias the visual recognition means.

A vehicle visual recognition device of a third aspect of the present invention is the vehicle visual recognition device of the second aspect of the present invention, further including a blocking body that blocks off an inside of the covering portion, that supports the operating mechanism, and that supplies electric power to the operating mechanism.

### Advantageous Effects

In the vehicle visual recognition device of the first aspect of the present invention, the visual recognition means assists the visual recognition by the occupant of the vehicle. The housing body houses the visual recognition means, and the opening in the housing body exposes the visual recognition means. The central support portion supports the center side of the visual recognition means so as to be capable of tilting and the outer peripheral support portion supports the outer peripheral side of the visual recognition means so as to be capable of sliding.

Note that the central support portion and the outer peripheral support portion are provided at the housing body. This enables the relative placement accuracy of a peripheral face at the opening in the housing body, the central support portion, and the outer peripheral support portion to be improved, and enables placement accuracy of the visual recognition means with respect to the peripheral face at the opening in the housing body to be improved.

In the vehicle visual recognition device of the second aspect of the present invention, the visual recognition means assists the visual recognition by the occupant of the vehicle. The housing body houses the visual recognition means, the opening in the housing body exposes the visual recognition means, and the central support portion supports the center side of the visual recognition means so as to be capable of tilting. The operating mechanism is covered by the covering portion and supports the visual recognition means. The operating mechanism is operated to tilt the visual recognition means.

Note that the central support portion and the covering portion are provided at the housing body. This enables relative placement accuracy of the peripheral face at the opening in the housing body, the central support portion, and the covering portion to be improved, enables relative placement accuracy of the peripheral face at the opening in the housing body, the central support portion, and the operating mechanism to be improved, and enables placement accuracy of the visual recognition means with respect to the peripheral face at the opening in the housing body to be improved.

In the vehicle visual recognition device of the fourth aspect of the present invention, the biasing means is retained by the retention portion, and the abutting portion abuts the biasing means so as to bias the visual recognition means.

Note that the retention portion that is provided at one of the visual recognition means or the housing body, and the abutting portion is provided at the other of the visual recognition means or the housing body. This enables the relative placement accuracy of the retention portion or the abutting portion provided at the housing body, the central support portion, and the outer peripheral support portion or the operating mechanism to be improved, enables the relative placement accuracy of the one of the biasing means or the abutting portion disposed on the housing body and the other of the biasing means or the abutting portion disposed on the visual recognition means to be improved, and enables the accuracy with which the biasing means biases the visual recognition means to be improved.

In the vehicle visual recognition device of the third aspect of the present invention, the blocking body blocks off the inside of the covering portion, the blocking body supports the operating mechanism, and the blocking body supplies electric power to the operating mechanism. This enables the operating mechanism to be supported and enables electric power to be supplied to the operating mechanism with a simple configuration.

### BRIEF DESCRIPTION OF DRAWINGS

FIG. 1 is an exploded perspective view of a vehicle door mirror device according to an exemplary embodiment of the present invention, as viewed from a vehicle front side and vehicle width direction inside.

FIG. 2 is a cross-section of relevant portions of the vehicle door mirror device according to the exemplary embodiment of the present invention, as viewed from a vehicle width direction outside.

FIG. 3 is a perspective view of a visor body of the vehicle door mirror device according to the exemplary embodiment of the present invention, as viewed from a vehicle rear side and vehicle width direction inside.

### DESCRIPTION OF EMBODIMENTS

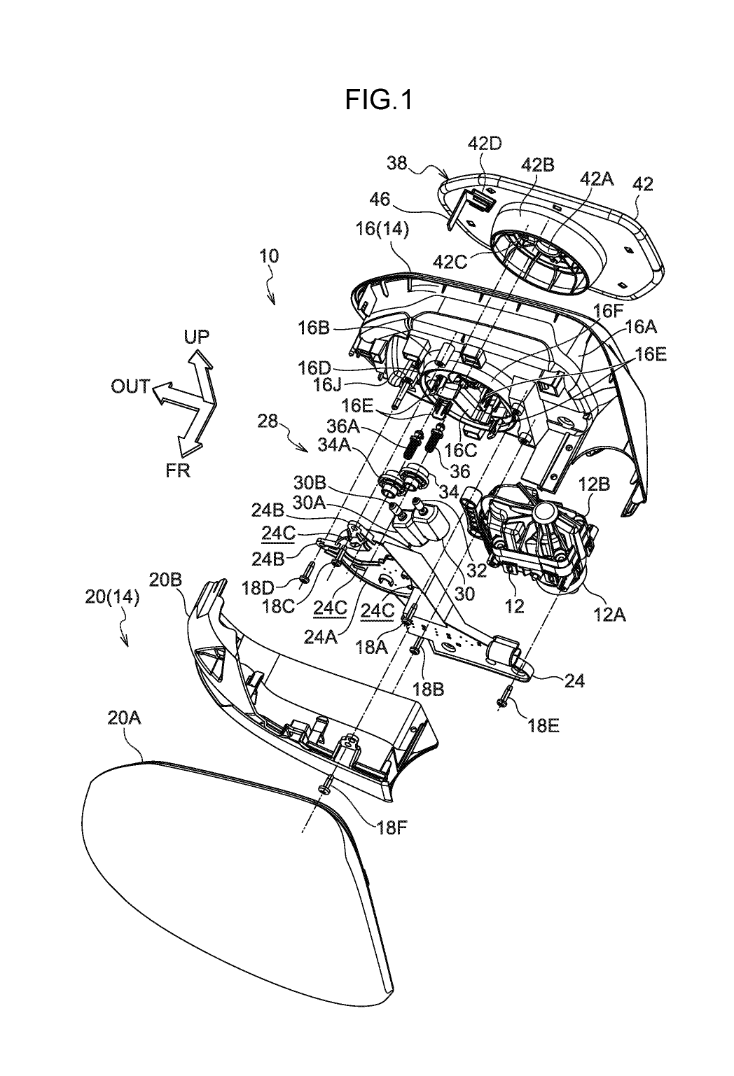

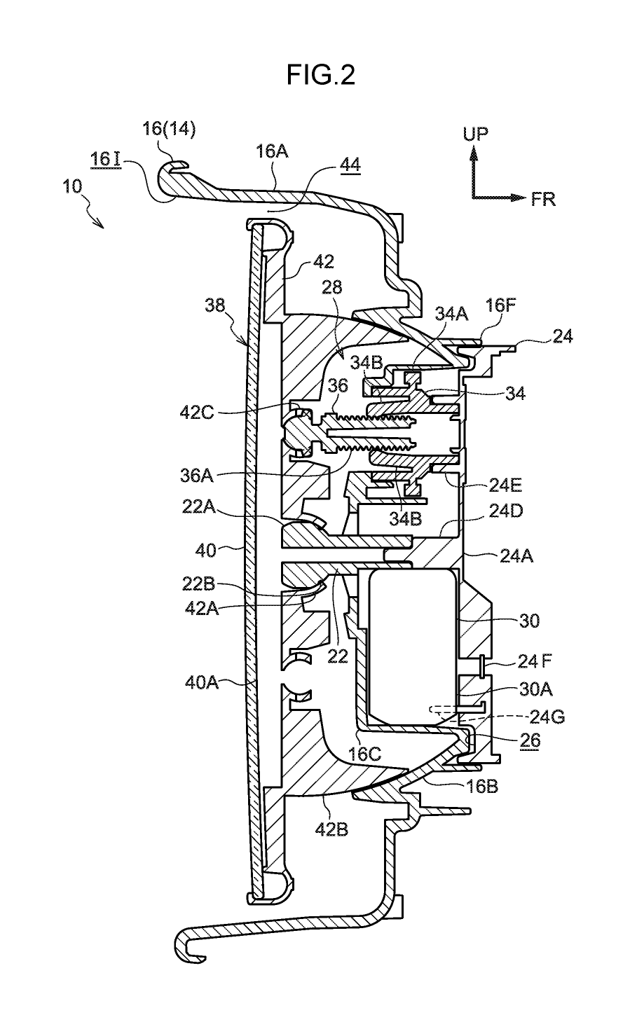

FIG. 1 is an exploded perspective view of a vehicle door mirror device 10, which serves as a vehicle visual recognition device according to an exemplary embodiment of the present invention, as viewed from a vehicle front side and vehicle width direction inside (vehicle left side). FIG. 2 is a cross-section of relevant portions of the vehicle door mirror device 10, as viewed from a vehicle width direction outside (vehicle right side). Note that in the drawings the arrow FR indicates a direction toward the vehicle front, the arrow OUT indicates a vehicle width direction outside, and the arrow UP indicates upwards.

The vehicle door mirror device 10 according to the present exemplary embodiment is supported at an outside of a door (front side door, vehicle body side) of a vehicle.

As illustrated in FIG. 1, the vehicle door mirror device 10 includes a stowing mechanism 12. A stand 12A, which serves as a shaft member, is provided to the stowing mechanism 12. The vehicle door mirror device 10 is supported on the door by the stand 12A being supported at a vehicle front side end of an up-down direction intermediate portion of the door. A swing body 12B is supported by the stand 12A. The swing body 12B is swung about a vertical axis with respect to the stand 12A by electrically operating the stowing mechanism 12. The swing body 12B is electrically connected to a controller (not illustrated in the drawings) on the vehicle body side, and the stowing mechanism 12 is electrically operated under control by the controller.

A visor 14, which is made from resin and serves as an outer peripheral body, is supported on the swing body 12B of the stowing mechanism 12. A visor body 16, which serves as a support body, is provided to the visor 14. The swing body 12B is fixed to a vehicle front side of a vehicle width direction inside end portion of the visor body 16, such as by fastening a first screw 18A and a second screw 18B, which serve as assembly members. A visor cover 20, which has a curved plate shape and serves as a covering member, is assembled at the vehicle front side of the visor body 16 with reinforcement 24, described below, interposed therebetween. An outer periphery of the visor cover 20 is fitted to an outer periphery of the visor body 16, so that the visor cover 20 covers the vehicle front side of the visor body 16. An upper cover 20A is provided at an upper side of the visor cover 20, and a lower cover 20B is provided at a lower side thereof. The visor cover 20 is configured by combining the upper cover 20A and the lower cover 20B.

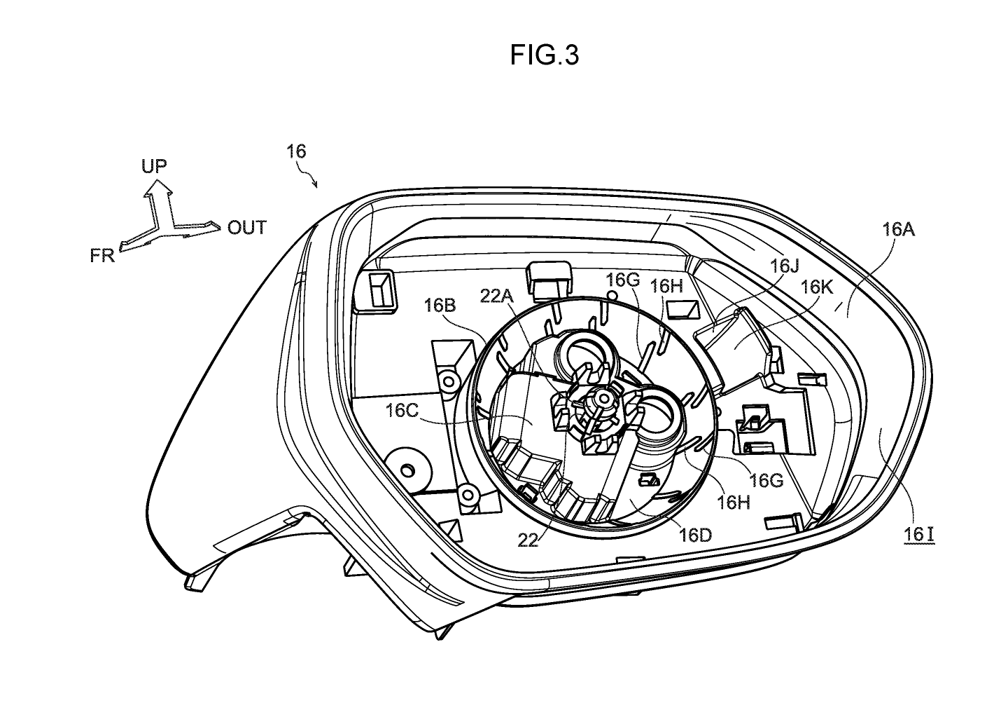

As illustrated in FIG. 1 to FIG. 3, a substantially cuboid box-shaped housing wall 16A, which serves as a housing section, is provided to the visor body 16. A vehicle rear side face of the housing wall 16A is open, forming a substantially rectangular shaped opening 16I. The inside of the housing wall 16A is open toward the vehicle rear side at the opening 16I.

A support wall 16B (case lower portion), which serves as an outer periphery support portion, is integrally provided to a vehicle front side wall (bottom wall) of the housing wall 16A. The support wall 16B projects out to the vehicle front side and vehicle rear side of the vehicle front side wall of the housing wall 16A. The support wall 16B is substantially cylindrical in shape, and is disposed such that a center axis line of the support wall 16B is parallel to the vehicle front-rear direction. The support wall 16B has a spherical wall shape, with an internal diameter dimension of the support wall 16B gradually increasing on progression toward the vehicle rear.

Plural, elongated plate shaped support protrusions 16G, which serve as support locations, are integrally provided to an inner peripheral face of the support wall 16B. The support protrusions 16G project out from the inner peripheral face of the support wall 16B toward the center side of the support wall 16B, and projection end faces 16H (sliding faces) thereof are shaped as spherical faces centered about the center of the support wall 16B. Plural (three or more) of the support protrusions 16G are disposed at even spacings around the circumferential direction of the support wall 16B. Plural (two in the present exemplary embodiment) of the support protrusions 16G are disposed in the center axis line direction of the support wall 16B (vehicle front-rear direction). The plural support protrusions 16G in the center axis line direction of the support wall 16B are disposed so as to partially overlap each other in the center axis line direction of the support wall 16B. The support protrusions 16G are disposed along the entire support wall 16B in the center axis line direction.

A covering wall 16C (case upper portion), which has a receptacle shape and serves as a covering portion, is provided inside the support wall 16B. The entire periphery at a vehicle front side end of the covering wall 16C is integrated to the entire periphery at a vehicle front side end of the support wall 16B. A coupling wall 16D having a flat plate shape is integrally provided between the vehicle front side end of the covering wall 16C and the vehicle front side end of the support wall 16B. The coupling wall 16D couples together the vehicle front side end of the covering wall 16C and the vehicle front side end of the support wall 16B at parts where the vehicle front side end of the covering wall 16C and the vehicle front side end of the support wall 16B are not directly integrated together. The inside of the covering wall 16C is open toward the vehicle front side of the support wall 16B. The inside of the covering wall 16C is thereby open toward the vehicle front side of the housing wall 16A.

A predetermined number (four in the present exemplary embodiment) of rectangular plate shaped limiting plates 16E, serving as limiting portions, are integrally provided to the coupling wall 16D. The limiting plates 16E project out from the coupling wall 16D toward the vehicle front side. The predetermined number of limiting plates 16E are disposed at substantially even spacings around the circumferential direction of the support wall 16B. The limiting plates 16E are disposed so as to intersect the radial direction of the support wall 16B.

A fitting cylinder 16F, which has a circular cylindrical shape and serves as a fitting portion, is integrally provided to a vehicle front-rear direction intermediate portion on an outer peripheral face of the support wall 16B. The fitting cylinder 16F projects out from the support wall 16B toward the vehicle front side and is disposed coaxially to the support wall 16B.

A retention tube 22, which has a substantially circular tube shape and serves as an central support portion, is integrally provided to a vehicle rear side wall (bottom wall) of the covering wall 16C. The retention tube 22 projects out to the vehicle front side and the vehicle rear side of the vehicle rear side wall of the covering wall 16C, and is disposed coaxially to the support wall 16B. A retention ball 22A having a substantially spherical shape is provided at a vehicle rear side end portion of the retention tube 22. A peripheral face at a vehicle front side portion of the retention ball 22A configures a spherical face shaped retention face 22B (sliding face) with its center aligned with the center of the support wall 16B.

An abutting wall 16J, which has a substantially triangular prism shape and serves as an abutting portion, is integrally provided to a vehicle front side wall of the housing wall 16A at the vehicle width direction outside of the support wall 16B. The abutting wall 16J projects out toward the vehicle front side of the vehicle front side wall of the housing wall 16A, and opens toward the vehicle rear side of the vehicle front side wall of the housing wall 16A. A vehicle width direction outside wall of the abutting wall 16J projects toward the vehicle rear side of the vehicle front side wall of the housing wall 16A, and a vehicle width direction inside face of the vehicle width direction outside wall of the abutting wall 16J (an inner face of the abutting wall 16J) configures spherical face shaped abutting face 16K. The center of the abutting face 16K is aligned with the center of the support wall 16B.

The reinforcement 24, which is substantially made from resin in an elongated plate shape and serves as a blocking body (reinforcement body), is provided at the vehicle front side of the visor body 16 and of the swing body 12B of the stowing mechanism 12. A vehicle width direction intermediate portion of the reinforcement 24 is fixed, together with the swing body 12B, to the visor body 16 by fastening the first screw 18A and the second screw 18B.

A pair of assembly plates 24B, each of which has a triangular plate shape and serves as an assembly portion, are integrally provided to a vehicle width direction outside portion of the reinforcement 24. The pair of assembly plates 24B respectively project out to the upper side and the vehicle width direction outside of the reinforcement 24. The vehicle width direction outside portion of the reinforcement 24 at the pair of assembly plates 24B is fixed to the visor body 16 by fastening a third screw 18C and a fourth screw 18D, each serving as an assembly member. A vehicle width direction inside end portion of the reinforcement 24 is fixed to the swing body 12B by fastening a fifth screw 18E, serving as an assembly member.

The reinforcement 24 has a higher rigidity than the visor body 16, and the reinforcement 24 reinforces the visor body 16 and the swing body 12B. The visor cover 20 (lower cover 20B) of the visor 14 is fixed to the reinforcement 24 by fastening a sixth screw 18F, serving as a fixing member. The visor cover 20 is thereby assembled to the visor body 16 with the reinforcement 24 interposed therebetween, as described above.

A bottom wall portion 24A, which has a circular plate shape and serves as a blocking portion, is provided to the vehicle width direction outside portion of the reinforcement 24. A recess portion 26, which serves as an insertion portion and has a rectangular profile in cross-section, is formed around the entire periphery of an outer peripheral portion at a vehicle rear side face of the bottom wall portion 24A. The bottom wall portion 24A is fitted inside the fitting cylinder 16F of the visor body 16, and a vehicle front side end of the support wall 16B of the visor body 16 is inserted into the recess portion 26. The outer peripheral face of the support wall 16B is fitted to an outer peripheral face of the recess portion 26. The vehicle front side of the support wall 16B and of the covering wall 16C of the visor body 16 are thereby covered and blocked off by the bottom wall portion 24A.

A predetermined number (four in the present exemplary embodiment) of limiting holes 24C, each having a rectangular shape and serving as a limiter portion, are formed penetrating the bottom wall portion 24A. The predetermined number of limiting holes 24C are disposed at substantially even spacings around the circumferential direction of the bottom wall portion 24A and are each disposed so as to intersect the radial direction of the bottom wall portion 24A. The limiting plates 16E of the visor body 16 are inserted (fitted) into the limiting holes 24C, thereby limiting movement of the bottom wall portion 24A in the circumferential direction and the radial direction with respect to the visor body 16.

A fit-insertion column 24D, which has a substantially circular column shape and serves as a fit-insertion portion, is integrally provided at a central portion of the bottom wall portion 24A. The fit-insertion column 24D projects out from the bottom wall portion 24A toward the vehicle rear side, and is disposed coaxially to the bottom wall portion 24A. A leading end portion of the fit-insertion column 24D has a reduced diameter. The leading end portion of the fit-insertion column 24D is fit-inserted inside the retention tube 22 of the visor body 16 from the vehicle front side.

Circular tube shaped support tubes 24E are integrally provided to an upper portion and vehicle width direction outside portion of the bottom wall portion 24A, at the bottom wall portion 24A-radial direction inside of each of the assembly plates 24B. Each of the support tubes 24E projects out from the bottom wall portion 24A toward the vehicle rear side, and is disposed with a center axis line parallel to the center axis line of the bottom wall portion 24A.

Plural wires 24F are provided to the reinforcement 24. The wires 24F are disposed inside the reinforcement 24, and base end sides of the wires 24F are electrically connected to the controller. Terminals 24G are electrically connected to leading ends of the wires 24E The terminals 24G are provided as two pairs that project out from the bottom wall portion 24A toward the vehicle rear side.

A mirror face adjustment mechanism 28, which serves as an operating mechanism, is retained (supported) between the covering wall 16C of the visor body 16 and the bottom wall portion 24A of the reinforcement 24.

A pair of motors 30, which serve as drive means, are provided in the mirror face adjustment mechanism 28. A main body 30A of each of the motors 30 is retained in a state positioned and clamped between the covering wall 16C and the bottom wall portion 24A. An output shaft 30B extends from the main body 30A, and a worm 32, which serves as an output member, is fixed to the output shaft 30B. A pair of the terminals 24G of the reinforcement 24 are electrically connected to each of the main bodies 30A. Electrical power is supplied to the motors 30 through the wires 24F and the terminals 24G of the reinforcement 24 under control of the controller, such that motors 30 are driven and the mirror face adjustment mechanism 28 is electrically operated.

A pair of wheel drives 34, which are each made from resin in a substantially circular tube shape and serve as transmission members, are provided in the mirror face adjustment mechanism 28. In a state in which a vehicle front side portion of each of the wheel drives 34 is fit-inserted into the support tubes 24E of the bottom wall portion 24A, the wheel drives 34 are positioned and clamped between the covering wall 16C and the bottom wall portion 24A and retained so as to be rotatable about their axes.

A worm wheel 34A is formed coaxially to an outer peripheral edge at an intermediate portion in the axial direction (vehicle front-rear direction) of each of the wheel drives 34. The worm wheels 34A are each meshed (engaged) with the respective worms 32 of the motors 30. Thus the worm wheels 34A are rotated by driving each of the motors 30 so as to rotate the worms 32, and the wheel drives 34 are rotated.

A predetermined number (four in the present exemplary embodiment) of meshing claws 34B, which serve as engaging portions, are formed to an inner peripheral portion of each of the wheel drives 34 at the vehicle rear side of the worm wheel 34A. The predetermined number of meshing claws 34B are disposed at even spacings around the circumferential direction of the wheel drive 34. The meshing claws 34B extend toward the vehicle rear side and are elastic. Leading ends (vehicle rear side ends) of the meshing claws 34B project toward the radial direction inside of the respective wheel drives 34.

A rod drive 36, which has a substantially circular column shape and serves as a supporting member (moving member), is coaxially inserted inside each of the wheel drives 34. Each of the rod drives 36 projects through the covering wall 16C toward the vehicle rear side. One of the rod drives 36 is disposed above (or alternatively below) a center axis line of the support wall 16B of the visor body 16. The other of the rod drives 36 is disposed at the vehicle width direction outside (or alternatively at the vehicle width direction inside) of the center axis line of the support wall 16B.

Portions other than leading end portions (vehicle rear side end portions) of the rod drives 36 configure respective threads 36A. The leading ends of the meshing claws 34B of the wheel drives 34 are meshed (engaged) with the respective threads 36A. The leading end portions of the rod drives 36 each have a substantially spherical shape.

A mirror body 38, which serves as a visual recognition means, is housed inside the housing wall 16A of the visor body 16. The entire periphery and vehicle front side of the mirror body 38 are respectively covered by a peripheral wall and a vehicle front side wall of the housing wall 16A. The mirror body 38 is exposed to a vehicle rear side of the visor body 16 through the opening 16I in the housing wall 16A.

A mirror 40, which has a substantially rectangular plate shape and serves as a visual recognition portion, is provided at a vehicle rear side portion of the mirror body 38. The surface of the mirror 40 points behind the vehicle. A mirror face 40A (the surface of a reflecting layer on a back side) of the mirror 40 points behind the vehicle. Vehicle rearward visual recognition by an occupant (in particular the driver) of the vehicle is assisted by the mirror 40.

A resin mirror holder 42, which has a substantially rectangular plate shape and serves as a supported body (sliding body) is provided to a vehicle front side portion of the mirror body 38. The mirror holder 42 fixes (retains) the entire periphery of the mirror 40 about its entire periphery, and covers the vehicle front side (back side) of the mirror 40. The outer peripheral shape of the mirror holder 42 has a similar shape, but is slightly smaller than, a peripheral face of the housing wall 16A at the opening 16I (a peripheral wall inner face of the housing wall 16A). A gap 44 is formed about the entire periphery between the outer periphery of the mirror holder 42 and the peripheral face at the opening 16I.

An attachment wall 42A, which has a substantially tube shape and serves as a central supported portion (attachment portion), is formed to the mirror holder 42 at a vehicle front side of a central position (center of gravity position) of the mirror 40. The attachment wall 42A is disposed coaxially to the support wall 16B of the visor body 16. The attachment wall 42A has a substantially spherical wall profile, with an inner diameter dimension of the attachment wall 42A gradually increasing on progression toward the vehicle rear. The retention ball 22A of the retention tube 22 of the visor body 16 is fit-inserted inside the attachment wall 42A. The attachment wall 42A is thereby retained (supported) on the retention face 22B of the retention ball 22A so as to be capable of tilting and sliding.

A sliding wall 42B, which has a substantially cylindrical shape and serves as an outer peripheral supported portion (sliding portion), is integrally provided at a vehicle front side of the mirror holder 42. The sliding wall 42B is disposed coaxially to the support wall 16B of the visor body 16. The sliding wall 42B has a spherical wall profile, and an external diameter dimension of the sliding wall 42B gradually increases on progression toward the vehicle rear. An outer peripheral face of the sliding wall 42B is abutted by the projection end faces 16H of the support protrusions 16G of the support wall 16B, and the sliding wall 42B is supported by the projection end faces 16H of the support protrusions 16G so as to be capable of tilting and sliding.

The mirror holder 42 includes a pair of swivel walls 42C, which each have a substantially tube shape and serve as a supported portion (swivel portion), formed at a radial direction inside of the sliding wall 42B. One of the swivel walls 42C is disposed above (or alternatively below) the center axis line of the support wall 16B of the visor body 16. The other of the swivel walls 42C is disposed at the vehicle width direction outside (or alternatively at the vehicle width direction inside) of the center axis line of the support wall 16B. The swivel walls 42C are disposed with the center axis lines thereof parallel to the center axis line of the support wall 16B of the visor body 16. The swivel walls 42C each have a substantially spherical wall profile, and an inner diameter dimension of each swivel wall 42C gradually increases on progression from the two vehicle front-rear direction end sides of the swivel wall 42C toward the vehicle front-rear direction center side thereof.

The leading end portions of the rod drives 36 of the mirror face adjustment mechanism 28 are fit-inserted into and retained (supported) by the swivel walls 42C. The swivel walls 42C are permitted to swivel with respect to the leading end portions of the respective rod drives 36, but rotation about the axes of the rod drive 36 is restricted. Thus, as stated above, in the mirror face adjustment mechanism 28, as the wheel drives 34 (including the meshing claws 34B) are rotated, the meshing position of the leading ends of the meshing claws 34B with the threads 36A of the respective rod drives 36 is displaced, and the respective rod drives 36 are moved (slide) in the vehicle front-rear direction (axial direction).

A retention frame 42D, which serves as a retention portion, is integrally provided to the vehicle front side of the mirror holder 42 at the vehicle width direction outside of the sliding wall 42B. A base end side portion of the spring 46, which has an L-plate shaped cross-section profile and serves as a biasing means, is retained by (fixed to) the retention frame 42D. A leading end side portion of the spring 46 extends toward the vehicle front side from the retention frame 42D. A leading end (vehicle front side end) of the spring 46 is abutted by the abutting face 16K of the abutting wall 16J of the visor body 16. The leading end side portion of the spring 46 undergoes elastic deformation in its thickness direction, and the spring 46 biases the mirror body 38. Thus, when the vehicle is traveling, for example, vibration of the mirror body 38 is restricted and juddering of the mirror 40 is suppressed by the biasing force of the spring 46.

Explanation follows regarding operation of the present exemplary embodiment.

In the vehicle door mirror device 10 configured as described above, the swing body 12B swings with respect to the stand 12A by electrical operation of the stowing mechanism 12, and the mirror body 38 (including the visor 14 (the visor body 16 and the visor cover 20), the reinforcement 24, and the mirror face adjustment mechanism 28) swing as a unit with the swing body 12B. The mirror body 38 thereby swings toward the vehicle rear side and the vehicle width direction inside, and the mirror body 38 is stowed. Moreover, the mirror body 38 is flipped out (deployed, returned) by the mirror body 38 being swung toward the vehicle front side and the vehicle width direction outside.

Moreover, when the motors 30 are driven by electrically operating the mirror face adjustment mechanism 28 so as to rotate the worms 32, the wheel drives 34 are rotated, and the rod drives 36 moved in the vehicle front-rear direction. Thus, by the mirror body 38 (the mirror 40 and the mirror holder 42) being tilted by the rod drives 36 in at least one of the up-down direction or the vehicle width direction, the angle of the mirror face 40A of the mirror 40 (i.e. the visual recognition direction of the occupant assisted by the mirror 40) is adjusted in at least one of the up-down direction or the vehicle width direction.

The attachment wall 42A of the mirror body 38 is retained (supported) by the retention face 22B of the retention ball 22A of the retention tube 22 of the visor body 16 so as to be capable of tilting and capable of sliding. Moreover, the sliding wall 42B of the mirror body 38 is supported by the projection end faces 16H of the support protrusions 16G of the support wall 16B of the visor body 16 so as also to be capable of tilting and capable of sliding. The swivel walls 42C of the mirror body 38 are retained (supported) by the leading end portions of the rod drives 36 of the mirror face adjustment mechanism 28 so as to be capable of sliding, and the spring 46 of the mirror body 38 is abutted by the abutting face 16K of the abutting wall 16J of the visor body 16.

When the mirror body 38 is tilted, the attachment wall 42A of the mirror body 38 slides over the retention tube 22 (retention face 22B) of the visor body 16, and the sliding wall 42B of the mirror body 38 slides over the support wall 16B (projection end faces 16H) of the visor body 16. Moreover, the swivel walls 42C of the mirror body 38 slide over the leading end portions of the rod drives 36 of the mirror face adjustment mechanism 28, and the spring 46 of the mirror body 38 slides over the abutting wall 16J (abutting face 16K) of the visor body 16.

Note that the mirror body 38 is exposed at the vehicle rear side of the visor body 16 through the opening 16I in the visor body 16 (housing wall 16A), and that the retention tube 22, the support wall 16B, and the covering wall 16C are integrally provided to the visor body 16. This enables the relative placement accuracy of the peripheral face at the opening 16I (the peripheral wall inner face of the housing wall 16A), the retention tube 22, the support wall 16B, and the covering wall 16C to be improved. Moreover, the covering wall 16C retains the wheel drives 34 and the wheel drives 34 support the rod drives 36, thereby enabling the relative placement accuracy of the peripheral face at the opening 16I, the retention tube 22, the support wall 16B, and the rod drives 36 to be improved. Furthermore, the retention tube 22, the support wall 16B, and the rod drives 36 are respectively supported by the attachment wall 42A, the sliding wall 42B, and the swivel walls 42C of the mirror body 38, thereby enabling the placement accuracy of the mirror body 38 with respect to the peripheral face at the opening 16I to be improved. This enables the accuracy of the dimensions of the gap 44 between the peripheral face at the opening 16I and the outer periphery of the mirror body 38 (the outer periphery of the mirror holder 42) to be improved, enables the gap 44 to be stabilized (made uniform, for example) about its entire periphery, enables the gap 44 to be set small, and enables the appearance of the gap 44 portion of the vehicle door mirror device 10 to be improved.

Since the retention tube 22, the support wall 16B, and the covering wall 16C are integrally provided to the visor body 16, the strength with which the mirror body 38 is supported by the retention tube 22, the support wall 16B, and the rod drives 36 can be improved. Since the covering wall 16C is integrally provided to the retention tube 22 and the support wall 16B, the relative placement accuracy of the mirror face adjustment mechanism 28 retained by the covering wall 16C and the mirror body 38 supported by the retention tube 22 and the support wall 16B can be improved, enabling the swivel walls 42C of the mirror body 38 to be suitably retained by the leading end portions of the rod drives 36.

The abutting wall 16J is also integrally provided to the visor body 16. This enables the relative placement accuracy of the abutting wall 16J, the retention tube 22, the support wall 16B, and the covering wall 16C that are integrally provided to the visor body 16 to be improved, enabling the relative placement accuracy of the abutting wall 16J and the mirror body 38 to be improved. The retention frame 42D is integrally provided to the mirror body 38 (mirror holder 42) and the spring 46 is retained by the retention frame 42D, thereby enabling the relative placement accuracy of the abutting wall 16J and the spring 46 to be improved. This enables the accuracy with which the abutting wall 16J (abutting face 16K) abuts the spring 46 to be improved, enables the accuracy with which the spring 46 biases the mirror body 38 to be improved, and enables juddering of the mirror 40 to be effectively suppressed.

The housing wall 16A, the retention tube 22, the support wall 16B, the covering wall 16C, and the abutting wall 16J are integrally provided to the visor body 16. This enables the number of components to be reduced, enabling costs to be reduced, and enables the relative placement accuracy of the housing wall 16A, the retention tube 22, the support wall 16B, the covering wall 16C, and the abutting wall 16J to be easily improved, enabling manufacturing costs to be reduced.

The bottom wall portion 24A of the reinforcement 24 blocks off the inside of the covering wall 16C of the visor body 16, the mirror face adjustment mechanism 28 is retained between the bottom wall portion 24A and the covering wall 16C, and the terminals 24G of the bottom wall portion 24A supply electric power to the motors 30 of the mirror face adjustment mechanism 28. This enables the mirror face adjustment mechanism 28 to be retained and enables electric power to be supplied to the motors 30 using a simple configuration.

Note that in the present exemplary embodiment, the support wall 16B and the covering wall 16C are integrally provided to the housing wall 16A and the retention tube 22. However, it is sufficient that at least one of the support wall 16B or the covering wall 16C is integrally provided to the housing wall 16A and the retention tube 22.

In the present exemplary embodiment, the retention frame 42D and the spring 46 are disposed on the mirror body 38, and the abutting wall 16J is disposed on the visor body 16. However, the retention frame 42D and the spring 46 may be disposed on the visor body 16, and the abutting wall 16J may be disposed on the mirror body 38.

In the present exemplary embodiment, the mirror body 38 is the visual recognition means. However, a camera that assists the visual recognition by an occupant by capturing images may be provided as a visual recognition means.

In the present exemplary embodiment, the vehicle door mirror device 10 (vehicle visual recognition device) is installed at the outside of a door of a vehicle. However, the vehicle mirror device may be installed at another position on a vehicle.

The entire content of the disclosure of Japanese Patent Application No. 2016-51486 filed on Mar. 15, 2016 is incorporated by reference in the present specification.

### EXPLANATION OF THE REFERENCE NUMERALS

10 vehicle door mirror device (vehicle visual recognition device)
16 visor body (housing body)
16B support wall (outer support portion)
16C covering wall (covering portion)
16I opening
16J abutting wall (abutting portion)
22 retention tube (central support portion)
24 reinforcement (blocking body)
28 mirror face adjustment mechanism (operating mechanism)
38 mirror body (visual recognition means)
42D retention frame (retention portion)
46 spring (biasing means)

1. A vehicle visual recognition device comprising:
a visual recognition means that assists visual recognition by an occupant of a vehicle; and
a housing body that houses the visual recognition means, that is provided with an opening exposing the visual recognition means, and that is provided with a central support portion supporting a center side of the visual recognition means so as to be capable of tilting and with an outer peripheral support portion supporting an outer peripheral side of the visual recognition means so as to be capable of sliding.

2. A vehicle visual recognition device comprising:
a visual recognition means that assists visual recognition by an occupant of a vehicle;
a housing body that houses the visual recognition means, that is provided with an opening exposing the visual recognition means, and that is provided with a covering portion and with a central support portion supporting a center side of the visual recognition means so as to be capable of tilting; and
an operating mechanism that is covered by the covering portion, that supports the visual recognition means, and that is operated to tilt the visual recognition means

3. The vehicle visual recognition device of claim 2, further comprising a blocking body that blocks off an inside of the covering portion, that supports the operating mechanism, and that supplies electric power to the operating mechanism.

4. The vehicle visual recognition device of claim 2, wherein the covering portion supports the operating mechanism.

5. The vehicle visual recognition device of claim 1, further comprising:
a retention portion that is provided at one of the visual recognition means or the housing body;
a biasing means that is retained by the retention portion; and
an abutting portion that is provided at the other of the visual recognition means or the housing body and that is abutted by the biasing means so as to bias the visual recognition means.
